(19) United States
(12) Patent Application Publication
(10) Pub. No.: US 2020/0285921 A1
(43) Pub. Date: Sep. 10, 2020

(54) INCONSPICUOUS ELECTROMAGNETIC TRANSPONDERS

(71) Applicant: SENSORMATIC ELECTRONICS, LLC, Boca Raton, FL (US)

(72) Inventor: Gopal CHANDRAMOWLE, Boca Raton, FL (US)

(21) Appl. No.: 16/811,969

(22) Filed: Mar. 6, 2020

Related U.S. Application Data
(60) Provisional application No. 62/814,785, filed on Mar. 6, 2019.

(51) Int. Cl. G06K 19/02; G06K 19/077; G06K 19/07

(52) U.S. Cl. CPC G06K 19/027; G06K 19/07762; G06K 19/0723; G06K 19/07773

(57) ABSTRACT

An electromagnetic tag includes a transponder and a housing. The transponder comprises an antenna. The housing is characterized by a form factor of a particular element of an article of manufacture, and accommodates the transponder. Accommodating includes forming the antenna on an exterior surface of the housing. The element is characterized by a purpose in the article other than transponding, and the housing is adapted to the purpose of the particular element.

### CROSS-REFERENCE TO RELATED APPLICATIONS

This application claims the benefit of U.S. Provisional Application Ser. No. 62/814,785, entitled “GARMENT FASTENING STRUCTURES HAVING DETECTABLE SENSOR ELEMENTS INTEGRATED THEREIN” and on filed Mar. 6, 2019, which is expressly incorporated by reference herein in its entirety.

### TECHNICAL FIELD

The technology disclosed herein relates to electromagnetic transponders that can be attached to articles of manufacture. Particular examples disclosed herein relate to incorporating RF identification (RFID) devices having a small form factor into a permanent or semi-permanent portion of an article such that the presence of the RFID device, and the persistent operation thereof is less discernable.

### BACKGROUND

In the retail industry, transponders in the form of RF tags may be attached to articles of manufacture for purposes of monitoring the location of the articles and/or for the interrogation of the tags to retrieve data stored thereon. These tags may be detachable hard tags, which may contain RFID sensors, Electronic Article Surveillance (EAS) sensors, and various combinations of EAS and RFID functions that may provide for theft deterrence, facilitate inventory operations, etc. EAS functionality may also be implemented by RFID functions, thus obviating the need for separate EAS sensor components within the tags.

### SUMMARY

Examples of the technology disclosed herein include electromagnetic transponders along with methods of use thereof and articles including the transponders. In some examples, an electromagnetic tag includes a transponder and a housing. The transponder comprises an antenna. The housing is characterized by a form factor of a particular element of an article of manufacture, and accommodates the transponder. Accommodating includes forming the antenna on an exterior surface of the housing. The element is characterized by a purpose in the article other than transponding, and the housing is adapted to the purpose of the particular element.

Examples of the technology disclosed herein include an article of manufacture. The article includes one or more elements (each element characterized by a primary purpose in the article other than transponding). A particular element of the one or more elements includes a transponder and a housing. The transponder includes an antenna. The housing is characterized by a form factor of the particular element, is adapted to the purpose of the particular element; and accommodates the transponder. Accommodating includes forming the antenna on an exterior surface of the housing.

Examples of the technology disclosed herein include methods of identifying an article of manufacture. In such examples, an article of manufacture includes one or more elements (each element characterized by a primary purpose in the article other than transponding). The method includes providing a tag that includes a transponder and a housing. The transponder includes an antenna. The housing is characterized by a form factor of the particular element, is adapted to the purpose of the particular element; and accommodates the transponder. Accommodating includes forming the antenna on an exterior surface of the housing. The method further includes integrating the tag into the particular element.

In some examples, an electromagnetic tag includes a transponder and a housing. The housing is characterized by a form factor complimentary to a back side of an element of an article of manufacture, is adapted to be non-inhibiting to the purpose of the element and attached to the back side thereof, and accommodates the transponder. The element is characterized by a purpose in the article other than transponding, and the housing is adapted to the purpose of the particular element.

Examples of the technology disclosed herein include an article of manufacture. The article includes one or more elements (each element characterized by a primary purpose in the article other than transponding). A particular element of the one or more elements includes a transponder and a housing. The housing is characterized by a form factor complimentary to a back side of an element of an article of manufacture, is adapted to be non-inhibiting to the purpose of the element and attached to the back side thereof, and accommodates the transponder.

Examples of the technology disclosed herein include methods of identifying an article of manufacture. In such examples, an article of manufacture includes one or more elements (each element characterized by a primary purpose in the article other than transponding). The method includes providing a tag that includes a transponder and a housing. The housing is characterized by a form factor complimentary to a back side of an element of an article of manufacture, is adapted to be non-inhibiting to the purpose of the element and attached to the back side thereof, and accommodates the transponder. Accommodating includes forming the antenna on an exterior surface of the housing. The method further includes integrating the tag into the particular element.

### BRIEF DESCRIPTION OF THE DRAWINGS

FIG. 1 illustrates an architecture for an exemplary electromagnetic transponder, in this case an electronic smart tag (EST).

FIG. 2 illustrates a disassembled electromagnetic tag, in accordance with examples of the technology disclosed herein.

FIG. 3 illustrates a section of an article of manufacture with the tag integrated therewith, in accordance with examples of the technology disclosed herein.

FIG. 4 is a block diagram illustrating methods of identifying an article of manufacture, in accordance with examples of the technology disclosed herein.

FIG. 5 illustrates an electromagnetic tag, in accordance with examples of the technology disclosed herein.

FIG. 6 is a block diagram illustrating methods of identifying an article of manufacture, in accordance with examples of the technology disclosed herein.

### DETAILED DESCRIPTION

When RF tags are attached to articles, whether the tags are RF, RFID, EAS or a combination of thereof, the presence of the RF tag may usually be readily observed by casual inspection. The visual appearance of the tag, as well as the physical obstructions created for the consumer handling/trying on manufacture, may detract from the quality of the shopping experience.

When hard RF tags are attached to articles of manufacture, store personnel may have to perform the additional steps of detaching the tag after the item is purchased by a customer using a dedicated detacher device. Until the RF tag is detached by store associates, the customer may view the article as unusable. If the associate fails to detach the tag properly, the customer may be forced to return to the retailer with proof of purchase in order to have the RF tag removed.

Examples of the technology disclosed herein include electromagnetic transponders along with methods of use thereof and articles including the transponders. In some examples of an electromagnetic tag or an article of manufacture, or a method, in addition to those aspects described in the Summary above, the element is a fastener of the article. In some examples, transponder is one or more of a Radio Frequency Identification (RFID) transponder and Electronic Article Surveillance (EAS) transponder. In some examples, the article is a garment, the housing is a fabric of the garment, and the antenna is a conductive thread of the fabric of the garment. In some examples, accommodating comprises forming therein a cavity containing at least a portion of the transponder. In some examples, the transponder is adapted to receive, store thereon, and transmit in response to a query one or more article events.

These and other aspects, objects, features, and advantages of the example examples will become apparent to those having ordinary skill in the art upon consideration of the following detailed description of illustrated example examples. Turning now to the drawings, in which like numerals represent like (but not necessarily identical) elements throughout the figures, example examples are described in detail.

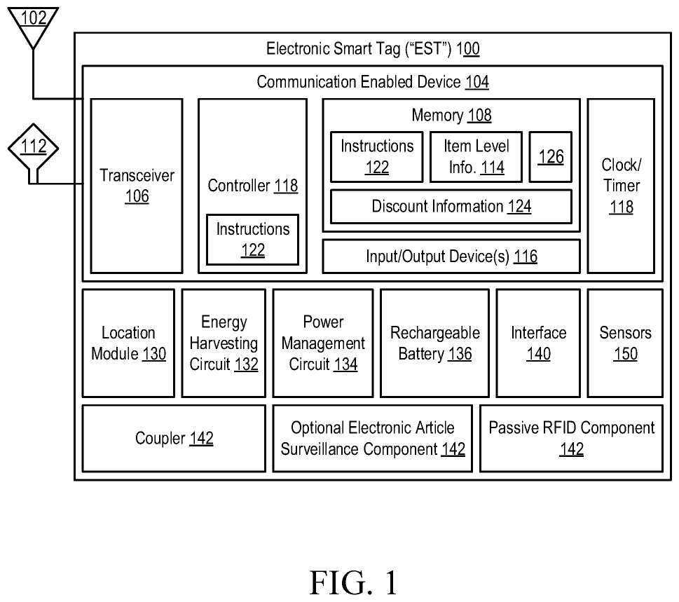

FIG. 1 illustrates an architecture for an exemplary electromagnetic transponder, in this case an electronic smart tag (EST) 100. While FIG. 1 illustrates an EST, much simpler tags can be used in the technology disclosed herein. The EST 100 can include more or less components than that shown in FIG. 1. However, the components shown are sufficient to disclose an illustrative example used in conjunction with the technology disclosed herein. Some or all of the components of the EST 100 can be implemented in hardware, software and/or a combination of hardware and software. The hardware includes, but is not limited to, one or more electronic circuits. The electronic circuit(s) may comprise passive components (e.g., capacitors and resistors) and active components (e.g., processors) arranged and/or programmed to implement the methods disclosed herein.

The hardware architecture of FIG. 1 represents a representative EST 100 configured to facilitate improved inventory management, manufacture sales, and/or customer experience. In this regard, the EST 100 is configured for allowing data to be exchanged with an external device via wireless communication technology. The wireless communication technology can include, but is not limited to, a Radio Frequency Identification (“RFID”) technology, an NFC technology, and/or a Short Range Communication (“SRC”) technology. For example, one or more of the following wireless communication technologies (is)are employed: Radio Frequency (“RF”) communication technology; Bluetooth technology; WiFi technology; Sub-GHz technology; beacon technology; and/or LiFi technology. Each of the listed wireless communication technologies is well known in the art, and therefore will not be described in detail herein. Any known or to be known wireless communication technology or other wireless communication technology can be used herein without limitation.

The components 106-118 shown in FIG. 1 may be collectively referred to herein as a communication enabled device 104, and includes a memory 108 and a clock/timer 118. Memory 108 may be a volatile memory and/or a non-volatile memory. For example, the memory 108 can include, but is not limited to, Random Access Memory (“RAM”), Dynamic RAM (“DRAM”), Static RAM (“SRAM”), Read Only Memory (“ROM”), and flash memory. The memory 108 may also comprise unsecure memory and/or secure memory.

In some scenarios, the communication enabled device 104 comprises a Software Defined Radio (“SDR”). SDRs are well known in the art, and therefore will not be described in detail herein. However, it should be noted that the SDR can be programmatically assigned any communication protocol that is chosen by a user (e.g., RFID, WiFi, LiFi, Bluetooth, BLE, Nest, ZWave, Zigbee, etc.). The communication protocols are part of the device's firmware and reside in memory 108. Notably, the communication protocols can be downloaded to the device at any given time. The initial/default role (being an RFID, WiFi, LiFi, etc. tag) can be assigned at the deployment thereof. If the user desires to use another protocol later, the user can remotely change the communication protocol of the deployed EST 100. The update of the firmware, in case of issues, can also be performed remotely.

As shown in FIG. 1, the communication enabled device 104 comprises at least one antenna 102, 112 for allowing data to be exchanged with the external device via a wireless communication technology (e.g., an RFID technology, an NFC technology and/or a SRC technology). The antenna 102, 112 is configured to receive signals from the external device and/or transmit signals generated by the communication enabled device 104. In some scenarios, the antenna 102, 112 comprises a near-field or far-field antenna. The antennas include, but are not limited to, a chip antenna or a loop antenna.

The communication enabled device 104 also comprises a transceiver 106. Transceivers are well known in the art, and therefore will not be described herein. However, it should be understood that the transceiver 106 generates and transmits signals (e.g., RF carrier signals) to external devices, as well as receives signals (e.g., RF signals) transmitted from external devices. In this way, the communication enabled device 104 facilitates the registration, identification, location, and/or tracking of an item to which the EST 100 is coupled. The communication enabled device 104 also facilitates the automatic and dynamic modification of item level information and/or discount information that is being or is to be output from the EST 100 in response to certain trigger events. The trigger events can include, but are not limited to, the EST's arrival at a particular facility, the EST's arrival in a particular country or geographic region, a date occurrence, a time occurrence, a price change, the reception of user instructions, the detection of an individual in proximity to an item to which the EST is coupled, the detection motion/movement of an item to which the EST is coupled, and/or the detection that the number of sales of the item have fallen below a threshold value over a given period of time.

Item level information 114 and/or discount information 124, and/or other information 126 associated with the identification, location and/or motion/movement of the EST 100 can be stored in memory 108 of the communication enabled device 104 and/or communicated to other external devices via transceiver 106 and/or interface 140 (e.g., an Internet Protocol or cellular network interface). For example, the communication enabled device 104 can communicate information specifying a timestamp, a unique identifier, item description, item price, a currency symbol, a price discount, location information, and/or motion/movement information to an external computing device. The external computing device (e.g., server) can then store the information in a datastore and/or use the information during language and/or currency conversion operations and/or during tag display change operations. The communication enabled device 104 also comprises a controller (or processor circuit) 110 and input/output devices 116. The controller 110 can also execute instructions 122 implementing methods for facilitating item inventorying, manufacture sales and/or customer satisfaction. In this regard, the controller 110 includes a processor (or logic circuitry that responds to instructions) and the memory 108 includes a computer-readable storage medium on which is stored one or more sets of instructions 122 (e.g., software code) configured to implement one or more of the methodologies, procedures, or functions described herein. The instructions 112 can also reside, completely or at least partially, within the controller 110 during execution thereof by the EST 100. The memory 108 and the controller 110 also can constitute machine-readable media. The term “machine-readable media,” as used here, refers to a single medium or multiple media (e.g., a centralized or distributed database, and/or associated caches and servers) that store the one or more sets of instructions 122. The term “machine-readable media”, as used here, also refers to any medium that is capable of storing, encoding or carrying a set of instructions 122 for execution by the EST 100 and that cause the EST 100 to perform any one or more of the methodologies of the present disclosure.

The input/output devices can include, but are not limited to, a display (e.g., an E Ink display, an LCD display, and/or an active matrix display), a speaker, a keypad, and/or light emitting diodes. The display is used to present item level information and/or discount information in a textual format and/or graphical format. Similarly, the speaker may be used to output item level information and/or discount information in an auditory format. The speaker and/or light emitting diodes may be used to output alerts for drawing a person's attention to the EST 100 and/or for notifying the person of a particular pricing status (e.g., on sale status) of the item to which the EST is coupled.

The clock/timer 118 is configured to determine a date, a time, and/or an expiration of a pre-defined period. Technique for determining these listed items are well known in the art, and therefore will not be described herein. Any known or to be known technique for determining these listed items can be used herein without limitation.

The EST 100 also comprises an optional location module 130. The location module 130 is generally configured to determine the geographic location of the EST at any given time. For example, in some scenarios, the location module 130 employs Global Positioning System (“GPS”) technology and/or Internet based local time acquisition technology. The present technology is not limited to the particulars of this example. Any known or to be known technique for determining a geographic location can be used herein without limitation.

The optional coupler 142 is provided to securely or removably couple the EST 100 to an item, such as an article of manufacture. The coupler 142 includes, but is not limited to, a mechanical coupling means (e.g., a strap, clip, clamp, snap) and/or adhesive (e.g., glue or sticker). The coupler 142 is optional since the coupling can be achieved via a weld and/or chemical bond.

The EST 100 can also include a rechargeable battery 136, an optional Electronic Article Surveillance (“EAS”) component 144, and/or a passive/active/semi-passive RFID component 146. Each of the listed optional components 136, 144, 146 is well known in the art, and therefore will not be described herein. Any known or to be known battery, EAS component and/or RFID component can be used herein without limitation.

The EST 100 further comprises an energy harvesting circuit 132 and a power management circuit 134 for ensuring continuous operation of the EST 100 without the need to change a battery. In some scenarios, the energy harvesting circuit is configured to harvest energy from one or more sources (e.g., heat, light, vibration, magnetic field, and/or RF energy) and to generate a relatively low amount of output power from the harvested energy. By employing multiple sources for harvesting, the device can continue to charge despite the depletion of a source of energy.

The energy harvesting circuit 132 can operate in two (2) ways. First, the energy harvesting circuit 132 can harvest energy from an available source while online (i.e., when the EST 100 is attached to manufacture). Second, the energy harvesting circuit 132 can harvest energy while offline (i.e., when the EST 100 is detached from manufacture) via a charging station/bin. This ensures that the EST 100 is fully charged when the EST is ready to be deployed or go online.

The energy harvesting circuit 132 can also be supplemented with bigger harvesters and/or a mains power source. In this case, the energy harvesting circuit 132 can be placed closer to its primary source (e.g., a solar panel on top of a shelf) and power from there can be distributed over two (2) wires. The design allows multiple labels to be connected to a single harvester circuit. The harvester circuit can be replaces with the mains power source.

The EST 100 may also include optional sensors 150 employing environmental and proximity sensing technology. The sensors 150 can include, but are not limited to, a light sensor, a fluid/liquid/humidity sensor, an IR detector, a camera, a proximity sensor, an IMU, an accelerometer, a gyroscope, and/or an RF detection unit. The input/output devices 116 (e.g., the display) can be turned off when a person is not located in proximity thereto. This capability is useful when the input/output devices 116 (e.g., the display) is not considered low power.

The power management circuit 134 is generally configured to control the supply of power to components of the EST 100. In the event all of the storage and harvesting resources deplete to a point where the EST 100 is about to enter a shutdown/brownout state, the power management circuit 134 can cause an alert to be sent from the EST 100 to a remote device (e.g., computing device 112 of FIG. 1). In response to the alert, the remote device can inform an associate (e.g., a store employee) so that (s)he can investigate why the EST 100 is not recharging and/or holding charge.

The power management circuit 134 is also capable of redirecting an energy source to the EST's 100 electronics based on the energy source's status. For example, if harvested energy is sufficient to run the EST 100 functions, the power management circuit 134 confirms that all of the EST 100 storage sources are fully charged such that the EST 100 electronic components can be run directly from the harvested energy. This ensures that the EST 100 always has stored energy in case harvesting source(s) disappear or lesser energy is harvested for reasons such as drop in RF, light or vibration power levels. If a sudden drop in any of the energy sources is detected, the power management circuit 134 can cause an alert condition to be sent from the EST 100 to the remote device (e.g., computing device 112 of FIG. 1). At this point, an investigation may be required as to what caused this alarm. Accordingly, the remote device can inform the associate (e.g., a store employee) so that (s)he can investigate the issue. It may be that other merchandise are obscuring the harvesting source or the item is being stolen.

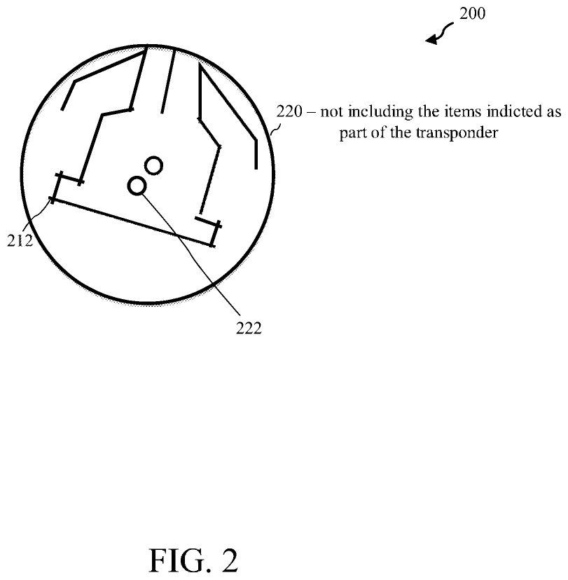

Referring to FIG. 2 and continuing to refer to FIG. 1 for context, an electromagnetic tag 200 is illustrated, in accordance with examples of the technology disclosed herein. The tag 200 includes a transponder (not entirely shown) and a housing 220. The transponder includes an antenna 212. Other transponder components, including a passive RFID component (akin to 142 as described in conjunction with FIG. 1) are embedded in housing 220. The housing 220 is characterized by a form factor of a particular element of an article of manufacture—in this case a button of a garment. The button/tag 200 can be attached to an article of manufacture, e.g., a garment, by conventional means of sewing through buttonholes 222. The housing 220 accommodates the transponder by embedding the transponder RFID component and by forming the transponder antenna 212 on an exterior surface of the housing.

In such examples, etching the transponder antenna directly on the button's 220 surface allows the etching pattern to be a decorative feature of the button. The etched antenna pattern enables RF communication functions of the transponder and at the same time, the appearance of the etching serves to render this function less conspicuous. In other examples, where the article is a garment and the housing is a fabric of the garment, the fabric can accommodate the antenna as a conductive thread in or on the fabric of the garment.

In some examples, accommodating includes forming a cavity in the housing (for example, by using a two-piece housing) containing at least a portion of the transponder. For example, a two-part housing can be in the form of a female portion of a snap fastener, for example as an element in an article of clothing such as a pair of jeans. The two-part housing can include a substrate in which the transponder RFID component is accommodated by embedding. The substrate can have formed therein a snap fastener socket for accepting the stud of a snap fastener. The two-part housing also can include a cap on which the antenna can be etched, including contacts that mate with corresponding RFID component contacts in the substrate. The cap can pressingly fit over the substrate and transponder to form a tag in the form of the female portion of a functioning snap fastener. In some examples, the transponder can be formed in the base of the post of the snap fastener—with vias and contacts to engage corresponding antenna contacts in the cap.

In some examples, the transponder is adapted to receive, store thereon, and transmit in response to a query one or more article events.

While more complex transponders including the range of features described in conjunction with FIG. 1 can be used, a simple transponder is used as an example above. While a passive RFID component was used as an example above, an electromagnetic tag can comprise other technologies as described above including an EAS transponder, and can include the other components discussed in connection with FIG. 1.

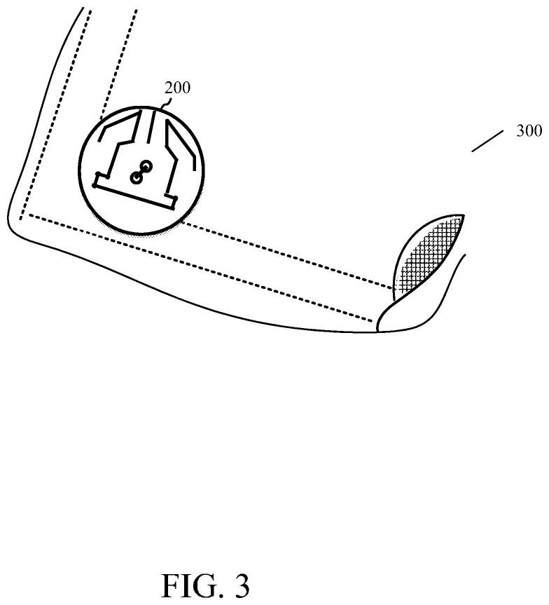

Referring to FIG. 3, and continuing to refer to prior figures for context, a section 300 of an article of manufacture with the tag 200 of FIG. 2 integrated therewith is illustrated, in accordance with examples of the technology disclosed herein.

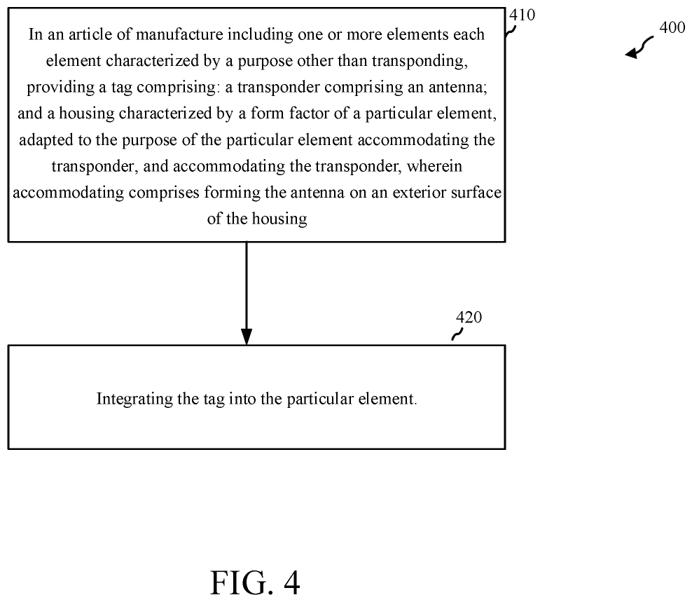

Referring to FIG. 4, and continuing to refer to prior figures for context, methods 400 of identifying an article of manufacture are illustrated, in accordance with examples of the technology disclosed herein. Such methods include, in an article of manufacture including one or more elements each element characterized by a purpose other than transponding, providing a tag comprising: a transponder comprising an antenna; and a housing characterized by a form factor of a particular element, adapted to the purpose of the particular element accommodating the transponder, and accommodating the transponder, wherein accommodating comprises forming the antenna on an exterior surface of the housing—Block 410. As an example, tag 200 of FIG. 2 is provided as a button closure for a pair of jeans. The tag is integrated into the particular element—Block 420. In the example, the button is integrated into the pair of jeans.

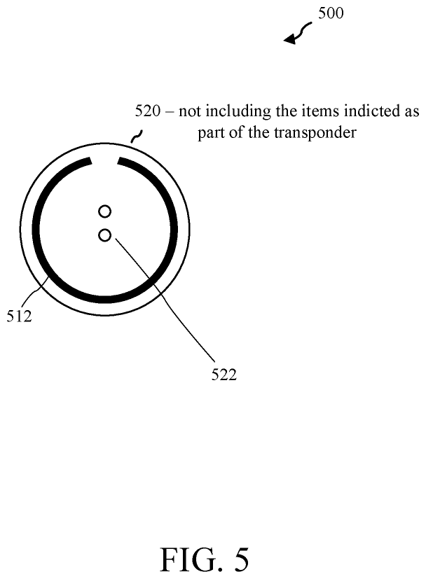

Referring to FIG. 5 and continuing to refer to FIG. 1 for context, an electromagnetic tag 500 is illustrated, in accordance with examples of the technology disclosed herein. The tag 500 includes a transponder (not entirely shown) and a housing 520. The transponder includes an antenna 512. Other transponder components, including a passive RFID component (akin to 142 as described in conjunction with FIG. 1) are embedded in housing 520. The housing 520 is characterized by a form factor complimentary to a back side of an element of an article of manufacture—in this case a button of a garment. The button/tag 500 can be attached to an article of manufacture, e.g., a garment, by conventional means of sewing through buttonholes 522. The housing 520 accommodates the transponder by embedding the transponder RFID component and by forming the transponder antenna 512 on an exterior surface of the housing.

Such tags 500 can be positioned behind a regular button so as to be less conspicuous than conventional tags. The substantially flat disk of tag 500 can be positioned between the article and the back side of a conventional button. The tag 500 can be attached to the conventional button using any suitable method, for example, by adhesives, or by press fitting the tag 500 into a mated recess formed in the conventional button. The tag 500 also can have one or more apertures 522 there through which can be aligned with the thread-receiving apertures of the conventional button. The tag 500 and conventional button can be sewn together onto the article.

In some examples, the transponder is adapted to receive, store thereon, and transmit in response to a query one or more article events.

While more complex transponders including the range of features described in conjunction with FIG. 1 can be used, a simple transponder. While a passive RFID component was used as an example above, an electromagnetic tag can comprise other technologies as described above including an EAS transponder, and can include the other components discussed in connection with FIG. 1.

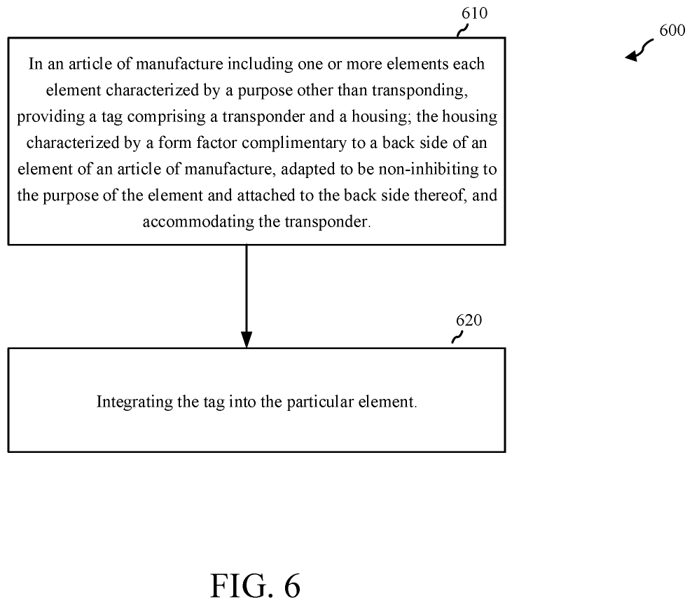

Referring to FIG. 6, and continuing to refer to prior figures for context, methods 400 of identifying an article of manufacture are illustrated, in accordance with examples of the technology disclosed herein. Such methods include, in an article of manufacture including one or more elements each element characterized by a purpose other than transponding, providing a tag comprising a transponder and a housing; the housing characterized by a form factor complimentary to a back side of an element of an article of manufacture, adapted to be non-inhibiting to the purpose of the element and attached to the back side thereof, and accommodating the transponder—Block 610. As an example, tag 200 of FIG. 2 can provided behind a button in a closure for a shirt collar. The tag is integrated into the particular element—Block 620. In the example, the button is integrated into the shirt to provide a closure at the shirt collar.

Methods of the technology disclosed herein can provide a detectable sensor, such as a passive RFID device that is permanently disposed in a portion of an article in such a manner that the presence of the sensor is visually less conspicuous than an conventional tag.

The RFID inlay includes an RF integrated circuit (IC) disposed on a substrate, with the IC being coupled to a conductive metallic antenna portion which may be etched into or otherwise adhered to the substrate. In a typical operating environment, the RFID device can be configured to have an operational range from approximately 815-935 MHz.

In one example, the RFID tag is in the form of a fully function garment button, and the RFID inlay is appropriated configured to have a profile sized to fit within a standard garment button. For a garment fastener other than a button or snap-type, it is contemplated that design choices for the RFID device can be made depending on the geometry of the type of garment fastener. In other examples, the RFID device can be incorporated into one or more portions of a garment zipper and configured accordingly.

In still other examples, the components of the RFID device can be disposed within a lanyard, belt, or cord. Portions of the RFID device can also be formed from conductive thread that can be woven into a garment.

The technology as described herein is not limited to textile applications. It is contemplated that any structural portion of an article can be adapted to contain a passive RF sensor such that the sensor is permanently incorporated into the article.

The technology as described herein is not limited to the use of RFID protocols to read data stored on the tag. Any number of RF communication protocols for passive tag interrogation can be utilized, including Near Field Communication (NFC). It is also contemplated that the RF tag can be operable in multiple communications protocol environments to provide multiple modes of use. For example, before the article is sold, the retailer may rely on RFID data for inventory purposes, but after the article is purchased, the consumer may wish to utilize the data transmission functionality of the embedded RF tag in other applications, which may be useful to the consumer.

The technology advantageously facilitates Self-Checkout operations within the retail store, thus enhancing the customer's shopping experience. Another advance of the technology is that retail sales associates do not need to spend time attaching and detaching RF tags. The sales associate is then freed to spend more time doing value added functions of suggesting/selling the manufacture instead of doing the clerical work of re-tagging/removal and point of sale (POS) operations.

The integration of the −RF tag into the structure of the article advantageously allows thee the entire transaction history for the item stored to be stored as data within the article itself. In this way, the purchased item effectively becomes the customer's receipt, and this greatly increases the ease at which refunds and exchanges can be made, for both the retailer and the consumer. For the retailer, returns and exchanges can be instantly and conclusively authenticated, without the need for the customer to produce a receipt. This is more convenient for both the customer and the retailer, and helps to prevent fraudulent exchanges.

Currently a hard tag or RFID based swing tickets are used in the store or the distribution center on clothing. Having an integrated RFID button-plastic [polyester], metal, shell, wood of different form factors can become integral part of the garment would be beneficial to inventory, security, and checkout. The technology disclosed herein can be deployed on all types of apparel—formal, sportswear, bags, etc.—that use buttons having various form factors that can be made of plastic or other materials including metal or metal-like buttons or snaps on jeans. In some examples, at least one tag of the present technology can be attached. With customer experience becoming more relevant, ease of self checkout has become a selling point for the customer. Using the technology disclosed herein, a sales associate can spend more time doing value added functions of suggesting/selling the product instead of doing the clerical work of re-tagging/removal & POS checkout. The technology disclosed herein can also help with refunds/replacement as it can be authenticated it was bought without needing the receipt-avoiding fraudulent exchanges. Examples of the technology disclosed hereon can stay for the life of the product but will be compliant with applicable privacy laws, for example General Data Protection Regulation (GDPR), by locking required features in the chip to avoid tracking or removal of the button. The technology disclosed herein can be used in a distribution center DC for E-commerce fulfillment. In the button configuration, examples of the technology disclosed hereon can be the last button or spare button provided attached to the garment. For use in the loss prevention function, a soft magnetic material/AM package can be embedded into the button, or a mated button/snap separate disc to be deactivated upon completion of a legitimate transaction. A carbon material can optionally be used to isolate the RFID inlay from magnetic influence.

The example systems, methods, and acts described in the examples presented previously are illustrative, and, in alternative examples, certain acts can be performed in a different order, in parallel with one another, omitted entirely, and/or combined between different example examples, and/or certain additional acts can be performed, without departing from the scope and spirit of various examples. Accordingly, such alternative examples are included in the scope of the following claims, which are to be accorded the broadest interpretation to encompass such alternate examples.

Although specific examples have been described above in detail, the description is merely for purposes of illustration. It should be appreciated, therefore, that many aspects described above are not intended as required or essential elements unless explicitly stated otherwise.

The following examples are illustrative only and aspects thereof may be combined with aspects of other embodiments or teaching described herein, without limitation.

Example 1 is a an article of manufacture, including one or more elements, each element characterized by a purpose other than transponding. For example, the purpose for example, the purpose of a button as an element of a garment can be fastening and/or decorative, and is not typically transponding. The purpose of a bill of a cap may be for shade and/or decoration, and not typically transponding. A particular element of the one or more elements comprising a transponder and a housing. The housing accommodating the transponder, characterized by a form factor of the particular element, and adapted to the purpose of the particular element.

Example 2 includes the article of Example 1 wherein the element is a fastener of the article. Example 3 includes any one of the articles of Example 1-2 wherein the transponder is one or more of a Radio Frequency Identification (RFID) transponder and Electronic Article Surveillance (EAS) transponder. Example 4 includes any one of the articles of Example 1-3 wherein the article is a garment; the transponder includes an antenna; the housing is a fabric of the garment; and the antenna is a conductive thread in the fabric of the garment. Example 5 includes any one of the articles of Example 1-4 wherein accommodating includes forming therein a cavity containing at least a portion of the transponder. Example 6 includes any one of the articles of Example 1-6 wherein the transponder includes an antenna, and accommodating comprises forming the antenna on the housing. Example 7 includes any one of the articles of Example 1-6, wherein the transponder is adapted to receive, store thereon, and transmit in response to a query one or more article events.

Example 8 is a an electromagnetic tag including a transponder and a housing. The housing accommodates the transponder, and is characterized by a form factor of a particular element of an article of manufacture. The element is characterized by a purpose in the article other than transponding, and the housing is adapted to the purpose of the particular element.

Example 9 includes the tag of Example 8 wherein the element is a fastener of the article. Example 10 includes any one of the tags of Example 8-9 wherein the transponder is one or more of a Radio Frequency Identification (RFID) transponder and Electronic Article Surveillance (EAS) transponder. Example 11 includes any one of the tags of Example 8-10 wherein the article is a garment; the transponder includes an antenna; the housing is a fabric of the garment; and the antenna is a conductive thread in the fabric of the garment. Example 12 includes any one of the tags of Example 8-11 wherein accommodating includes forming therein a cavity containing at least a portion of the transponder. Example 13 includes any one of the tags of Example 8-12 wherein the transponder includes an antenna, and accommodating comprises forming the antenna on the housing. Example 14 includes any one of the tags of Example 8-13, wherein the transponder is adapted to receive, store thereon, and transmit in response to a query one or more article events.

Example 15 is a method of identifying an article of manufacture. In the method, an article of manufacture includes one or more elements each element characterized by a purpose other than transponding. The method includes providing a tag comprising: a transponder; and a housing: accommodating the transponder, characterized by a form factor of a particular element, and adapted to the purpose of the particular element. The method further includes integrating the tag into the particular element.

Example 16 includes the method of Example 15 wherein the element is a fastener of the article. Example 17 includes any one of the tags of Example 15-16 wherein the transponder is one or more of a Radio Frequency Identification (RFID) transponder and Electronic Article Surveillance (EAS) transponder. Example 18 includes any one of the tags of Example 15-17 wherein the article is a garment; the transponder includes an antenna; the housing is a fabric of the garment; and the antenna is a conductive thread in the fabric of the garment. Example 19 includes any one of the tags of Example 15-18 wherein accommodating includes forming therein a cavity containing at least a portion of the transponder. Example 20 includes any one of the tags of Example 15-19 wherein the transponder includes an antenna, and accommodating comprises forming the antenna on the housing.

Example 18 is an article of manufacture, including one or more elements, each element characterized by a primary purpose in an article of manufacture other than transponding. A particular element of the one or more elements includes a transponder comprising an antenna; and a housing characterized by a form factor of the particular element, adapted to the purpose of the particular element, and accommodating the transponder, wherein accommodating comprises forming the antenna on an exterior surface of the housing.

Example 19 includes the article of Example 18 wherein the element is a fastener of the article. Example 20 includes any one of the articles of Example 18-19 wherein the transponder is one or more of a Radio Frequency Identification (RFID) transponder and Electronic Article Surveillance (EAS) transponder. Example 21 includes any one of the articles of Example 18-20 the article is a garment; the housing is a fabric of the garment; and the antenna is a conductive thread of the fabric of the garment. Example 22 includes any one of the articles of Example 18-21 wherein accommodating comprises forming therein a cavity containing at least a portion of the transponder. Example 23 includes any one of the articles of Example 18-22 wherein the transponder is adapted to receive, store thereon, and transmit in response to a query one or more article events.

Example 24 is an electromagnetic tag including a transponder comprising an antenna; and a housing characterized by a form factor of a particular element of an article of manufacture, and accommodating the transponder, wherein accommodating comprises forming the antenna on an exterior surface of the housing. The element is characterized by a purpose in the article other than transponding; and the housing is adapted to the purpose of the particular element.

Example 25 includes the tag of Example 24 wherein the element is a fastener of the article. Example 26 includes any one of the tag of Example 24-25 wherein the transponder is one or more of a Radio Frequency Identification (RFID) transponder and Electronic Article Surveillance (EAS) transponder. Example 27 includes any one of the tag of Example 24-26 the article is a garment; the housing is a fabric of the garment; and the antenna is a conductive thread of the fabric of the garment. Example 28 includes any one of the tag of Example 24-27 wherein accommodating comprises forming therein a cavity containing at least a portion of the transponder. Example 29 includes any one of the tag of Example 24-28 wherein the transponder is adapted to receive, store thereon, and transmit in response to a query one or more article events.

Example 30 is a method of identifying an article of manufacture including, in an article of manufacture comprising one or more elements each element characterized by a purpose other than transponding, providing a tag and a housing. The method includes a transponder comprising an antenna. The housing is characterized by a form factor of a particular element. The housing accommodates the transponder, wherein accommodating comprises forming the antenna on an exterior surface of the housing. The housing is adapted to the purpose of the particular element accommodating the transponder. The method further includes integrating the tag into the particular element.

Example 31 includes the method of Example 30 wherein the element is a fastener of the article. Example 32 includes any one of the methods of Example 30-31 wherein the transponder is one or more of a Radio Frequency Identification (RFID) transponder and Electronic Article Surveillance (EAS) transponder. Example 33 includes any one of the methods of Example 30-32 the article is a garment; the housing is a fabric of the garment; and the antenna is a conductive thread of the fabric of the garment. Example 34 includes any one of the methods of Example 30-33 wherein accommodating comprises forming therein a cavity containing at least a portion of the transponder. Example 35 includes any one of the methods of Example 30-34 wherein the transponder is adapted to receive, store thereon, and transmit in response to a query one or more article events.

Example 36 includes an electromagnetic tag including a transponder and a housing. The housing is characterized by a form factor complimentary to a back side of an element of an article of manufacture, adapted to be non-inhibiting to the purpose of the element and attached to the back side thereof, and accommodates the transponder. The element is characterized by a purpose in the article other than transponding.

Example 37 includes the tag of claim 18, wherein the element is a fastener of the article. Example 38 includes any one of the tags of Examples 36-37 wherein the transponder is one or more of a Radio Frequency Identification (RFID) transponder and Electronic Article Surveillance (EAS) transponder. Example 39 includes any one of the tags of Examples 36-38 wherein accommodating comprises forming therein a cavity containing at least a portion of the transponder. Example 40 includes any one of the tags of Examples 36-39 wherein the transponder is adapted to receive, store thereon, and transmit in response to a query one or more article events.

Example 41 is an article of manufacture including one or more elements, each element characterized by a primary purpose other than transponding and an electromagnetic tag. The tag includes a transponder and housing. The housing is characterized by a form factor complimentary to a back side of an element of an article of manufacture, is adapted to be non-inhibiting to the purpose of the element and attached to the back side thereof; and accommodates the transponder.

Example 42 includes the article of Example 41 wherein the element is a fastener of the article. Example 43 includes the article of Examples 41-42 wherein the transponder is one or more of a Radio Frequency Identification (RFID) transponder and Electronic Article Surveillance (EAS) transponder. Example 44 includes the article of Examples 41-43 wherein accommodating further comprises forming therein a cavity containing at least a portion of the transponder. Example 45 includes the article of Examples 41-44 wherein the transponder is adapted to receive, store thereon, and transmit in response to a query one or more article events.

Example 46 is a method of identifying an article of manufacture. The article of manufacture includes one or more elements each element characterized by a purpose other than transponding. The method includes providing a tag comprising a transponder and a housing. The housing is characterized by a form factor complimentary to a back side of an element of an article of manufacture, is adapted to be non-inhibiting to the purpose of the element and attached to the back side thereof; and accommodates the transponder. The method includes integrating the tag into the particular element.

Example 47 includes the method of Example 46 wherein the element is a fastener of the article. Example 48 includes the method of any one of Examples 46-47 wherein the transponder is one or more of a Radio Frequency Identification (RFID) transponder and Electronic Article Surveillance (EAS) transponder. Example 49 includes the method of any one of Examples 46-48 wherein accommodating comprises forming therein a cavity containing at least a portion of the transponder.

Modifications of, and equivalent components or acts corresponding to, the disclosed aspects of the example examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

We claim:

1. An article of manufacture, comprising:
one or more elements, each element characterized by a primary purpose in an article of manufacture other than transponding;
a particular element of the one or more elements comprising:
a transponder comprising an antenna; and
a housing:
characterized by a form factor of the particular element;
adapted to the purpose of the particular element; and
accommodating the transponder, wherein accommodating comprises forming the antenna on an exterior surface of the housing.

2. The article of claim 1, wherein the element is a fastener of the article.

3. The article of claim 1, wherein the transponder is one or more of a Radio Frequency Identification (RFID) transponder and Electronic Article Surveillance (EAS) transponder.

4. The article of claim 1, wherein:
the article is a garment;
the housing is a fabric of the garment; and
the antenna is a conductive thread of the fabric of the garment.

5. The article of claim 1, wherein accommodating comprises forming therein a cavity containing at least a portion of the transponder.

6. The article of claim 1, wherein the transponder is adapted to receive, store thereon, and transmit in response to a query one or more article events.

7. An electromagnetic tag, comprising:
a transponder comprising an antenna; and
a housing:
characterized by a form factor of a particular element of an article of manufacture; and
accommodating the transponder, wherein accommodating comprises forming the antenna on an exterior surface of the housing;
wherein:
the element is characterized by a purpose in the article other than transponding; and
the housing is adapted to the purpose of the particular element.

8. The tag of claim 7, wherein the element is a fastener of the article.

9. The tag of claim 7, wherein the transponder is one or more of a Radio Frequency Identification (RFID) transponder and Electronic Article Surveillance (EAS) transponder.

10. The tag of claim 7, wherein:
the article is a garment;
the housing is a fabric of the garment; and
the antenna is a conductive thread of the fabric of the garment.

11. The tag of claim 7, wherein:
accommodating comprises forming therein a cavity containing at least a portion of the transponder.

12. The tag of claim 7, wherein:
the transponder is adapted to receive, store thereon, and transmit in response to a query one or more article events.

13. A method of identifying an article of manufacture, comprising:
in an article of manufacture comprising one or more elements each element characterized by a purpose other than transponding:
providing a tag comprising:
a transponder comprising an antenna; and
a housing: characterized by a form factor of a particular element; accommodating the transponder, wherein accommodating comprises forming the antenna on an exterior surface of the housing; and adapted to the purpose of the particular element accommodating the transponder; and
integrating the tag into the particular element.

14. The method of claim 13, wherein the element is a fastener of the article.

15. The method of claim 13, wherein the transponder is one or more of a Radio Frequency Identification (RFID) transponder and Electronic Article Surveillance (EAS) transponder.

16. The method of claim 13, wherein:
the article is a garment;
the housing is a fabric of the garment; and
the antenna is a conductive thread in the fabric of the garment.

17. The method of claim 13, wherein:
accommodating comprises forming therein a cavity containing at least a portion of the transponder.

18. An electromagnetic tag, comprising:
a transponder; and
a housing:
characterized by a form factor complimentary to a back side of an element of an article of manufacture;
adapted to be non-inhibiting to the purpose of the element and attached to the back side thereof; and
accommodating the transponder;
wherein the element is characterized by a purpose in the article other than transponding.

19. The tag of claim 18, wherein the element is a fastener of the article.

20. The tag of claim 18, wherein the transponder is one or more of a Radio Frequency Identification (RFID) transponder and Electronic Article Surveillance (EAS) transponder.

21. The tag of claim 18, wherein accommodating comprises forming therein a cavity containing at least a portion of the transponder.

22. The tag of claim 18, wherein the transponder is adapted to receive, store thereon, and transmit in response to a query one or more article events.

23. An article of manufacture, comprising:
one or more elements, each element characterized by a primary purpose other than transponding; and
an electromagnetic tag, comprising:
a transponder; and
a housing:
characterized by a form factor complimentary to a back side of an element of an article of manufacture;
adapted to be non-inhibiting to the purpose of the element and attached to the back side thereof; and
accommodating the transponder.

24. The article of claim 23, wherein the element is a fastener of the article.

25. The article of claim 23, wherein the transponder is one or more of a Radio Frequency Identification (RFID) transponder and Electronic Article Surveillance (EAS) transponder.

26. The article of claim 23, wherein accommodating further comprises forming therein a cavity containing at least a portion of the transponder.

27. The article of claim 23, wherein the transponder is adapted to receive, store thereon, and transmit in response to a query one or more article events.

28. A method of identifying an article of manufacture, comprising:
in an article of manufacture comprising one or more elements each element characterized by a purpose other than transponding:
providing a tag comprising:
a transponder; and
a housing:
characterized by a form factor complimentary to a back side of an element of an article of manufacture;
adapted to be non-inhibiting to the purpose of the element and attached to the back side thereof; and
accommodating the transponder; and
integrating the tag into the particular element.

29. The method of claim 28, wherein the element is a fastener of the article.

30. The method of claim 28, wherein the transponder is one or more of a Radio Frequency Identification (RFID) transponder and Electronic Article Surveillance (EAS) transponder.

31. The method of claim 28, wherein accommodating comprises forming therein a cavity containing at least a portion of the transponder.
